(19) United States
(12) Patent Application Publication
(10) Pub. No.: US 2026/0339705 A1
(43) Pub. Date: Oct. 29, 2026

(54) METHOD, APPARATUS, AND COMPUTER PROGRAM FOR SCHEDULING INFERENCE OPERATION UNITS

(71) Applicant: SAMSUNG SDS CO., LTD., Seoul (KR)

(72) Inventors: Seungbeom CHOI, Seoul (KR); Kyungmin BIN, Seoul (KR); Hyojung LEE, Seoul (KR); Daehyeon BAEK, Seoul (KR); Jimyoung SON, Seoul (KR); Daseul BAE, Seoul (KR); Jieun CHOI, Seoul (KR)

(73) Assignee: SAMSUNG SDS CO., LTD., Seoul (KR)

(21) Appl. No.: 19/656,093

(22) Filed: Apr. 23, 2026

(30) Foreign Application Priority Data
Apr. 25, 2025 (KR) 10-2025-0054424
Oct. 31, 2025 (KR) 10-2025-0161217

(51) Int. Cl. G06F 9/48; G06N 3/045

(52) U.S. Cl. CPC G06F 9/4881; G06N 3/045

(57) ABSTRACT

The present disclosure relates to a method, apparatus, and computer program for scheduling inference operation units. A method for scheduling inference operation units of the present disclosure may include a first scheduling operation of assigning one or more models to one or more GPUs; and a second scheduling operation of determining a batch-unit size of a prompt transmitted in real time to an inference operation system.

### CROSS-REFERENCE TO RELATED APPLICATION(S)

This application is based on and claims priority under 35 U.S.C. 119 to Korean Patent Application No. 10-2025-0054424, filed on Apr. 25, 2025, in the Korean Intellectual Property Office, and Korean Patent Application No. 10-2025-0161217, filed on Oct. 31, 2025, in the Korean Intellectual Property Office, the disclosure of which is herein incorporated by reference in its entirety.

### BACKGROUND OF THE INVENTION

### 1. Field of the Invention

The present disclosure relates to a method, apparatus, and computer program for scheduling inference operation units, more specifically, to a method, apparatus, and computer program for efficiently scheduling inference operation units in model units (or LLM instances) or batch units (batch units of prompts) and, even more specifically, to a method, apparatus, and computer program for improving computational and memory resource efficiency of a GPU by performing two-stage scheduling by distinguishing between model-unit inference operation unit scheduling and batch-unit inference operation unit scheduling.

### 2. Description of the Prior Art

Recently, with the widespread use of artificial intelligence services based on large language models (LLMs), methods for serving systems (inference operation systems) that perform LIM inference operations through multiple LLMs to efficiently utilize GPU resources are gaining attention.

Lightweighting techniques and methods in which multiple LLMs share GPUs are being introduced to enable LLMs, which require a large amount of memory, to efficiently utilize the resources of GPU clusters. Quantization is one of the lightweighting techniques, which is a technology that converts each component requiring memory in an LLM, such as weights, activations, and KV caches, into a lower bit-precision (e.g., INT4, FP8) rather than the existing high bit-precision (e.g., FP16) and stores it in memory.

Scheduling techniques implemented in existing GPU cluster-based LIM serving systems do not account for the heterogeneity of memory usage and performance across individual LLMs that arises from applying various quantization techniques to multiple LLMs. When performing LIM inference operations, the number of tokens capable of being stored in the KV cache determines the length of prompts capable of being processed by the LLM and the number of prompts capable of being processed concurrently, thereby influencing the performance of the LLM. However, since the bit-precision of tokens stored in the KV cache varies depending on the quantization technique, the number of tokens capable of being stored in the KV cache differs according to the quantization method. Consequently, existing techniques that consider only the weight of the LLM or maximize only the size of the KV cache available to the LLM, without considering the number of tokens capable of being stored in the KV cache (or the performance differences between LLMs due to differences in quantization techniques), have limitations in improving the resource efficiency or performance of the LLM serving system.

In other words, although there is a need for measures to improve the resource efficiency and performance of LLM serving systems in consideration of the differences (heterogeneity) in performance relative to memory usage among LLMs resulting from the application of various quantization techniques to multiple LLMs, an appropriate solution for this has not yet been presented.

### SUMMARY OF THE INVENTION

The present disclosure is designed to resolve the problems of the prior art described above and aims to provide a method, apparatus, and computer program for scheduling inference operation units (LLM instances or batch units of prompts).

Furthermore, the present disclosure aims to provide a method, apparatus, and computer program for scheduling inference operation units that consider the heterogeneity of KV cache memory usage and performance caused by different quantization techniques between LLMs.

Furthermore, the present disclosure aims to provide a method, apparatus, and computer program for scheduling inference operation units capable of separating the real-time resizing of required inference operation units (batch units) into separate scheduling operations.

Furthermore, the present disclosure aims to provide a method, apparatus, and computer program for scheduling inference operation units that schedule GPUs for each LLM instance to satisfy the throughput and service level objectives (SLOs) required for multiple LLMs with various quantization techniques, which are operated in a serving system, applied.

Furthermore, the present disclosure aims to provide a method, apparatus, and computer program for scheduling inference operation units capable of providing more stable performance by selecting a GPU capable of sufficiently meeting the expected KV cache memory usage of each LLM.

Furthermore, the present disclosure aims to provide a method, apparatus, and computer program for scheduling inference operation units that select a GPU capable of optimizing performance improvement relative to the remaining KV cache memory size when one or more models share a GPU.

Furthermore, the present disclosure aims to provide a method, apparatus, and computer program for scheduling inference operation units that optimize the number of tokens capable of being stored relative to the KV cache memory.

Furthermore, the present disclosure aims to provide a method, apparatus, and computer program for scheduling inference operation units capable of adjusting the batch size in real time so that the TTFT (Time-to-First-Token, the latency of the prefill step) of the prompt transmitted to the serving system satisfies the SLO.

In addition, the present disclosure aims to provide a method, apparatus, and computer program for scheduling inference operation units capable of further improving the quality of inference service of a serving system relative to input GPU resources.

The technical problems to be solved by the present disclosure are not limited to those mentioned above, and other technical problems not mentioned will be clearly understood by those skilled in the art to which the present in disclosure pertains from the description in this specification.

According to the first aspect of the present disclosure, a method for scheduling inference operation units may include: a first scheduling operation of assigning one or more models to one or more GPUs; and a second scheduling operation of determining a batch-unit size of a prompt transmitted in real time to an inference operation system.

Here, the first scheduling operation may include: calculating required memory for each of the models; sorting placement order of each of the models based on the required memory; calculating MME (Marginal Memory Efficiency) for each of the models; calculating, in a case where each of the models is placed on any one GPU (GPU(G)) among the one or more GPUS in the placement order, a score of the one GPU (GPU(G)); and sequentially placing each of the models according to the placement order on a GPU with the highest score among the one or more GPUs.

Here, the required memory may be a memory requirement including a weight size, activation size, and KV cache size of each of the models.

Here, the MME may be the number of tokens capable of being further processed by each of the models with a unit memory having a predetermined size provided.

Here, in a case where each of the models (M) is placed on any one GPU (GPU(G)) among the one or more GPUs, a score of the one GPU (GPU(G)) may be

$$score ( G \vert M ) = {\sum }_{i = 0}^{N} \frac{1}{\vert {G}_{i}^{′} \vert} {\sum }_{m ∈ {G}_{i}^{′}} μ ( m ) \cdot {K}_{re m} ( {G}_{i}^{′} )$$

G′={m|m is model determined to be placed on GPU G}∪{M}
Kᵣₑₘ(G′):=(total memory of GPU G)−Σ_{m∈G′}(required memory of model m),
and μ(m) may be the MME of model m, and |G′| may be the number of models determined to be placed on GPU G′.

Here, the second scheduling operation may include: calculating deadline of each prompt among at least one prompt waiting within the inference operation system; calculating an estimated time (TTFT) to perform chunked prefill for each prompt, and then calculating a completion time of the chunked prefill in consideration of the current time; dropping the prompt whose completion time of the chunked prefill exceeds the deadline from the inference operation system; forming a batch to perform chunked prefill on all prompts remaining within the inference operation system that are not dropped; calculating a completion time of the chunked prefill for the batch; based on the completion time of the chunked prefill for the batch not satisfying the deadline of all prompts within the batch, excluding the longest prompt among the prompts within the batch from the batch; and repeatedly executing the excluding of the longest prompt among the prompts within the batch from the batch until the completion time of the chunked prefill for the batch satisfies the deadline of all prompts within the batch.

Here, the deadline may be calculated as a sum of an arrival time and an SLO of each prompt.

Here, the method may further include performing chunked prefill for the batch in a case where the completion time of the chunked prefill for the batch satisfies the deadline of all prompts within the batch.

According to the second aspect of the present disclosure, there is provided a computer program stored on a medium for executing, in conjunction with hardware, the method of scheduling inference operation units.

According to the third aspect of the present disclosure, an apparatus for scheduling inference operation units may include a processor, wherein the processor may be configured to perform: first scheduling of assigning one or more models to one or more GPUs; and second scheduling of determining a batch-unit size of a prompt transmitted in real time to an inference operation system.

Here, the first scheduling may include: calculating required memory for each of the models; sorting placement order of each of the models based on the required memory; calculating MME (Marginal Memory Efficiency) for each of the models; calculating, in a case where each of the models is placed on any one GPU (GPU(G)) among the one or more GPUs in the placement order, a score of the one GPU (GPU(G)); and sequentially placing each of the models according to the placement order on a GPU with the highest score among the one or more GPUs.

Here, the required memory may be a memory requirement including a weight size, activation size, and KV cache size of each of the models.

Here, the MME may be the number of tokens capable of being further processed by each of the models with a unit memory having a predetermined size provided.

Here, in a case where each of the models (M) is placed on any one GPU (GPU(G)) among the one or more GPUs, a score of the one GPU (GPU(G)) may be

$$score ( G \vert M ) = {\sum }_{i = 0}^{N} \frac{1}{\vert {G}_{i}^{′} \vert} {\sum }_{m ∈ {G}_{i}^{′}} μ ( m ) \cdot {K}_{re m} ( {G}_{i}^{′} )$$

G′={m|m is model determined to be placed on GPU G}∪{M}
Kᵣₑₘ(G′):=(total memory of GPU G)−Σ_{m∈G′}(required memory of model m),
   and μ(m) may be the MME of model m, and |G′| may be the number of models determined to be placed on GPU G′.

Here, the second scheduling may include: calculating deadline of each prompt among at least one prompt waiting within the inference operation system; calculating an estimated time (TTFT) to perform chunked prefill for each prompt, and then calculating a completion time of the chunked prefill in consideration of the current time; dropping the prompt whose completion time of the chunked prefill exceeds the deadline from the inference operation system; forming a batch to perform chunked prefill on all prompts remaining within the inference operation system that are not dropped; calculating a completion time of the chunked prefill for the batch; based on the completion time of the chunked prefill for the batch not satisfying the deadline of all prompts within the batch, excluding the longest prompt among the prompts within the batch from the batch; and repeatedly executing the excluding of the longest prompt among the prompts within the batch from the batch until the completion time of the chunked prefill for the batch satisfies the deadline of all prompts within the batch.

Here, the deadline may be calculated as a sum of an arrival time and an SLO of each prompt.

Here, the processor may be configured to further perform chunked prefill for the batch in a case where the completion time of the chunked prefill for the batch satisfies the deadline of all prompts within the batch.

Accordingly, in the method, apparatus, and computer program for scheduling inference operation units according to an embodiment of the present disclosure, it is possible to provide inference operation unit scheduling in consideration of the heterogeneity of KV cache memory usage and performance caused by different quantization techniques between LLMs.

In addition, in the method, apparatus, and computer program for scheduling inference operation units according to an embodiment of the present disclosure, it is possible to separate the real-time resizing of required inference operation units (batch units) into separate scheduling operations.

In addition, in the method, apparatus, and computer program for scheduling inference operation units according to an embodiment of the present disclosure, it is possible to schedule GPUs for each LIM instance to satisfy the throughput and service level objectives (SLOs) required for multiple LLMs with various quantization techniques, which are operated in a serving system, applied.

In addition, in the method, apparatus, and computer program for scheduling inference operation units according to an embodiment of the present disclosure, it is possible to provide more stable performance by selecting a GPU capable of sufficiently meeting the expected KV cache memory usage of each LLM.

In addition, in the method, apparatus, and computer program for scheduling inference operation units according to an embodiment of the present disclosure, it is possible to select a GPU capable of optimizing performance improvement relative to the remaining KV cache memory size when one or more models share a GPU.

In addition, in the method, apparatus, and computer program for scheduling inference operation units according to an embodiment of the present disclosure, it is possible to optimize the number of tokens capable of being stored relative to the KV cache memory.

In addition, in the method, apparatus, and computer program for scheduling inference operation units according to an embodiment of the present disclosure, it is possible to adjust the batch size in real time so that the TTFT (Time-to-First-Token, latency of the prefill step) of the prompt transmitted to the serving system satisfies the SLO.

In addition, in the method, apparatus, and computer program for scheduling inference operation units according to an embodiment of the present disclosure, it is possible to further improve the quality of inference service of a serving system relative to input GPU resources.

The effects obtainable from the present disclosure are not limited to those mentioned above, and other unmentioned effects will be clearly understood by those skilled in the art to which the present disclosure belongs from the description in this specification.

### BRIEF DESCRIPTION OF THE DRAWINGS

The attached drawings, included as part of the detailed description to aid in understanding the present disclosure, provide embodiments of the present disclosure and explain the technical concept of the present disclosure together with the detailed description.

FIG. 1 illustrates the processing flow of a global scheduling operation according to an embodiment of the present disclosure.

FIG. 2 illustrates the pseudo-code of the processing flow of a global scheduling operation according to an embodiment of the present disclosure.

FIG. 3 illustrates the process of determining the placement order of each model depending on priority before selecting the optimal GPU to place each model in the model list according to an embodiment of the present disclosure.

FIG. 4 illustrates the process of placing each model in the model list on each GPU according to a score according to an embodiment of the present disclosure.

FIG. 5 illustrates a global scheduling method according to an embodiment of the present disclosure.

FIG. 6 illustrates a local scheduling method according to an embodiment of the present disclosure.

FIG. 7 illustrates the pseudo-code of the processing flow of a local scheduling operation according to an embodiment of the present disclosure.

FIG. 8 illustrates a method for scheduling inference operation units according to an embodiment of the present disclosure.

FIG. 9 illustrates an apparatus to which the proposed method of the present disclosure may be applied.

### DETAILED DESCRIPTION OF THE EXEMPLARY EMBODIMENTS

Hereinafter, the embodiments disclosed in this specification will be described in detail with reference to the attached drawings. The purpose, specific advantages, and novel features of the present disclosure will become clearer from the following detailed description and preferred embodiments associated with the attached drawings.

In addition, any terms or words used in this specification and claims are appropriately defined by the inventor to best describe his invention and should be interpreted in a sense and concept consistent with the technical concept of the present disclosure, and the terms are intended merely to describe the embodiments and should not be interpreted as limiting the present disclosure.

In assigning reference numerals to components, identical or similar components will be assigned the same reference numeral regardless of the reference numerals, and redundant descriptions thereof will be omitted. The terms “module” and “unit” used for elements in the following description are assigned or used interchangeably only for the convenience of drafting the specification, and do not have distinct meanings or roles in themselves, and may refer to software or hardware components.

In describing the components of the present disclosure, if a component is expressed in a singular form, it should be understood that the component also includes a plural form unless specifically stated otherwise. Furthermore, terms such as “first,” “second,” etc., are used to distinguish one component from another, and the components are not limited to the terms. Furthermore, if a component is connected to another component, it implies that another component may be connected between the two components.

Furthermore, in describing the embodiments disclosed in this specification, detailed descriptions of related prior art will be omitted when it is determined that such detailed descriptions may obscure the subject matter of the embodiments disclosed in this specification. In addition, the attached drawings are intended only to facilitate understanding of the embodiments disclosed in this specification, and the technical concept disclosed in this specification is not limited to the attached drawings, and it should be understood that they include all modifications, equivalents, and substitutions that fall within the concept and technical scope of the present disclosure.

Hereinafter, exemplary embodiments of a method, apparatus, and computer program for scheduling inference operation units according to the present disclosure will be described in detail with reference to the attached drawings.

The present disclosure proposes a scheduling technique for inference operation units (LLM instances) in consideration of the heterogeneity of KV cache memory usage and performance arising from different quantization techniques, and proposes a two-stage scheduling technique for inference operation units (LLM instances and batch units of prompts) in which the real-time resizing of required inference operation units (batch units) is separated into separate scheduling operations. In the present disclosure, the inference operation units of a serving system refer to LLM instances or batch units of prompts.

The first scheduling operation in the two-stage scheduling of inference operation units is the step of assigning an appropriate GPU to LIM instances and is defined as a global scheduling operation in the embodiment of the present disclosure.

In the global scheduling operation, GPUs are scheduled (assigned) to respective LIM instances to satisfy the throughput and service level objectives (SLOs) required for multiple LLMs with various quantization techniques, which are operated in a serving system, applied (in this case, all GPUS belonging to the GPU cluster are considered for assignment).

Since respective LLMS applied with different quantization techniques have different bit-precisions of KV cache tokens, more stable performance may be provided by predicting the expected KV cache memory usage of each LLM by taking this into account and selecting a GPU capable of providing sufficient usage. When predicting KV cache memory usage, both statistics on the number and length of requested prompts per unit time and the bit-precision of the KV cache tokens are considered based on the serving system's records, thereby predicting KV cache memory usage more accurately. Additionally, when one or more models share a GPU, a GPU is selected that may optimize performance improvement relative to the remaining KV cache memory size. In addition, a new metric called MME (Marginal Memory Efficiency), which represents the number of tokens capable of being stored relative to the KV cache memory, is newly defined and a scheduling technique to optimize this is proposed.

In summary, the first scheduling operation determines which LLM among multiple LLMs (model instances with different quantization techniques applied) will be assigned to which GPU across the entire GPU cluster. That is, in situations where multiple LLM instances (e.g., Llama quantized in INT4, Mistral quantized in FP8, etc.) must share GPU resources, GPU resource allocation is performed efficiently by considering the KV cache memory usage, bit precision, expected throughput, and SLO requirements needed by each LLM.

The second scheduling operation in the two-stage scheduling of inference operation units is a step of determining the size of batch units of prompts transmitted to the serving system in real time and is defined as a local scheduling operation in the embodiment of the present disclosure.

In the local scheduling operation, the batch size of prompts is adjusted in real-time so that the TTFT (Time-to-First-Token, i.e., the latency of the prefill step) of the prompts transmitted to the serving system satisfies the SLO. The number of prompts per hour or the length of prompts that the serving system actually needs to process changes in real-time. In order to respond to these changes in real-time, the process of determining the batch size that satisfies the SLO deadline is separated into a distinct scheduling operation, which is defined as a local scheduling operation. The local scheduling operation is performed individually on each server, and to make faster decisions, the scheduling targets are limited to the LLM of the responsible server. The local scheduling operation plays the role of managing the expected execution time of the prompts constituting the batch to ensure that they form the maximum batch size capable of satisfying the SLO deadline. If a waiting prompt fails to meet the SLO deadline even with the minimum batch size, that prompt is skipped (dropped) to prevent resource waste. Unlike conventional SLO-guaranteed scheduling techniques, the present disclosure guarantees SLOs based on more accurate execution times by reflecting the chunked prefill processing time, which is a prefill operation method.

Hereinafter, the global scheduling operation and local scheduling operation, which are two-stage scheduling of inference operation units that enables LLMs with various quantization techniques applied to utilize the computational and memory resources of a GPU cluster more efficiently, will be described in detail.

The global scheduling operation presents the optimal method for placing quantization models of various sizes (e.g., LLMs such as Llama-3.1-8B FP16, Llama-3.1-70B KV INT4, etc.) on GPUs when servicing them. Each model may be placed exclusively on a single GPU, or multiple models may be placed together on a single GPU. In addition, if a single model cannot handle user requests, the model may be placed by applying data parallelism, which is a method of processing replicas of the model in parallel across multiple GPUs, or tensor parallelism, which is a method of distributing and processing the weights and inputs of a single model in parallel across multiple GPUS.

### (1) Sorting the Placement Order According to Model Priority

Before selecting the optimal GPU (or GPU group) to place the models, the placement order of each model is determined according to priority.

To maximize latency SLO attainment, it is not sufficient to consider only the weight size, request rate, or SLO of each model. In order to allocate limited memory resources so that they are used efficiently even at the actual service time, it is necessary to estimate more realistic memory usage. In an embodiment of the present disclosure, the required memory is calculated using the optimal batch size that satisfies the request rate and SLO of each model on the basis of profiling information, and the placement priority is determined based on this.

(required memory)==(weight size)+(activation size)+(KV cache size)

Since required memory corresponds to the memory requirement that includes not only the weight size but also the activation size and KV cache size, it may reflect the actual memory size needed at the request processing time. Therefore, models must be placed based on the required memory rather than considering only the model's weight size to efficiently use memory at the actual service time. In the present disclosure, models with larger required memory values are prioritized for placement based on the required memory.

### (2) Definition of GPU Score for Model Placement

The scheduling of a serving system aims to ensure that as many requests as possible satisfy the latency SLO. TO achieve this goal, the global scheduling operation defines the MME (Marginal Memory Efficiency) of model M_Q (a model with KV precision Q) as follows.

μ(M_Q):=(Δgenerated tokens of model M with KV precision Q)/(ΔKV memory)

MME refers to the number of tokens capable of being further processed by a model when a unit memory of a predetermined size is given (here, the size of the unit memory is not determined by a specific memory size, but rather, for the purpose of comparing the processing performance (the number of processible tokens) between respective models, assuming that the respective models have memory of the same size). What is noteworthy here is that, given memory of the same size, the model (e.g., Llama-3.1-8B, Llama-3.1-70B) and its KV quantization format (e.g., FP16, FP8, INT4) determine the additional token processing capacity. In other words, the additional token processing capacity is determined by the precision format in which the KV cache of the corresponding model is stored (KV precision Q), and MME is an indicator that reflects this.

That is, the present disclosure proposes a method to find model-GPU placement cases that may maximize the token processing capacity for each model, based on the observation that the memory size of a unit token varies depending on the type of model and its quantization format.

For example, when attempting to place model M on a GPU, the score assigned to each candidate GPU is defined as follows.

$$score ( G \vert M ) := {max}_{Δ {K}_{m} > 0} {\sum }_{m ∈ {G}^{′}} μ ( m ) \cdot {K}_{m} s . t . {\sum }_{m ∈ {G}^{′}} Δ {K}_{m} \leq {K}_{re m} ( {G}^{′} )$$

Respective symbols appearing in the above equation are defined as follows.
G′={m|m is model determined to be placed on GPU G}∪{M}
Kᵣₑₘ(G′):=(total memory of GPU G)−Σ_{m∈G′}(required memory of model m)
ΔKₘ:=(additional KV memory allocatable to model m)

In the above equation, G′ represents a set of all models determined to be placed on GPU G, assuming that model M is determined to be placed on GPU G. Krem(G′) refers to the remaining memory of GPU G after subtracting the base memory requirement of G′ (the sum of estimated weights, activations, and KV cache sizes), which is estimated based on information such as latency and memory footprint obtained through profiling. ΔKm is the additional KV memory that may be allocated to model m in excess of the t base memory requirement. This indicates that there is a portion of the remaining memory, Krem(G′), that may be further allocated to model m, considering the case where the KV cache memory requirement when model m operates in actual service exceeds the pre-estimated memory requirement.

However, since the amount of additional KV memory (ΔKm) that each model is to actually use when serving inference services varies depending on the actual requirement for that model during inference service serving, it is practically difficult to estimate its size in advance. Therefore, assuming that additional KV memory is distributed evenly among all models, the score of GPU G under the condition that model M is placed on GPU G is approximated as follows. |G′| is the number of models determined to be placed on GPU G′.

$$score ( G \vert M ) = \frac{1}{\vert {G}^{′} \vert} {\sum }_{m ∈ {G}^{′}} μ ( m ) \cdot {K}_{re m} ( {G}^{′} )$$

According to the score definition above, the estimated memory requirement (sum of weights, activations, and KV cache sizes) of all models determined to be placed on the corresponding GPU, including model M, is considered first. Then, when allocating the remaining memory to the respective models, the number of tokens capable of being further processed by each model is further considered. In this case, the GPU with the highest capacity for additional token processing is selected, taking into account models that are co-located. Through this configuration, the present disclosure may place models on GPUs by considering not only the required memory to satisfy the request rate and SLO, but also the additional token processing capacity to prepare for potential traffic increases.

In the case of data parallelism in which model replicas are processed in parallel across multiple GPUs, the score defined above may be applied by treating each model replica as an independent single model.

In the case of a method (tensor parallelism) where the weights and inputs of a single model are distributed and processed in parallel across multiple GPUS (degree N), the above score may be generalized and applied as follows to a GPU group G composed of N GPUs and a model partition Mi (i: TP rank, a unique index of the model partition handled by each GPU within the tensor parallelism (TP) structure).

$$score ( G \vert M ) = {\sum }_{i = 0}^{N} \frac{1}{\vert {G}_{i}^{′} \vert} {\sum }_{m ∈ {G}_{i}^{′}} μ ( m ) \cdot {K}_{re m} ( {G}_{i}^{′} )$$

Respective symbols appearing in the above equation are defined as follows.

$${G}_{i}^{′} = \{ m \vert m is model determined to be placed on GPU {G}_{i} \} ⋃ \{ {M}_{i} \}$$

$${K}_{re m} ( {G}_{i}^{′} ) = ( total memory of GPU {G}_{i} ) - {\sum }_{m ∈ {G}^{′}} ( required memory of model m )$$

Therefore, in the case of tensor parallelism to which the above equation is applied, model M is placed in parallel on the GPU group with the highest score among the candidate GPU groups.

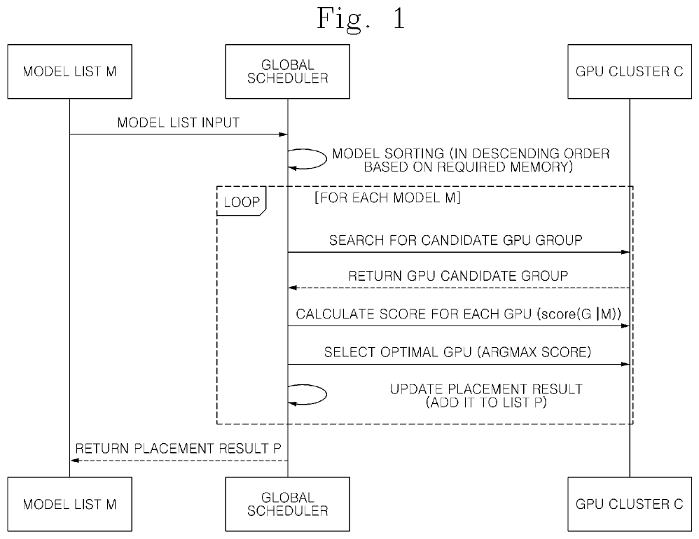

FIG. 1 illustrates the processing flow of a global scheduling operation according to an embodiment of the present disclosure.

When a list of models (model list M) to be placed on a GPU within a GPU cluster C is input into a global scheduler, which performs the global scheduling operation, the placement order (model sorting) of the respective models is determined based on priority before selecting the optimal GPU (or GPU group) to place each model in the model list. In the present disclosure, based on the previously described required memory, models with larger required memory values are placed first.

For each model with a determined priority, a search for candidate GPU groups is requested from the GPU cluster C, and the candidate GPU group is returned.

The GPU score of each GPU within the candidate GPU group is calculated, and the optimal GPU is selected based on the calculation result. When the optimal GPU for each model is selected, the placement result (the placement (allocation) of GPU resources for model instances or inference tasks) is updated (list P is updated).

When update of the list P is completed based on the optimal GPU selection for all models according to the model sorting order, the completed placement (the placement (allocation) of GPU resources for model instances or inference tasks) is returned.

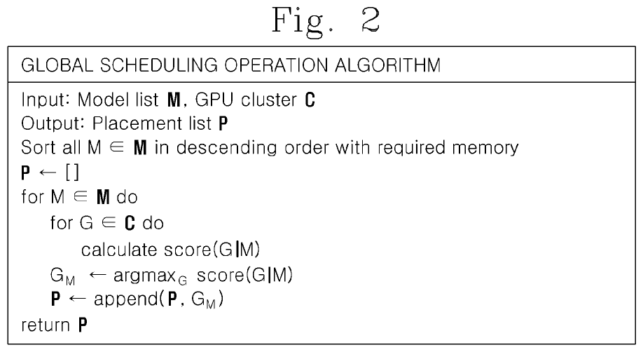

FIG. 2 illustrates the pseudo-code of the processing flow of a global scheduling operation according to an embodiment of the present disclosure.

Based on the results obtained through this global scheduling operation, each model is placed on a GPU, and subsequently, requests actually entering each LIM are processed through a local scheduling operation.

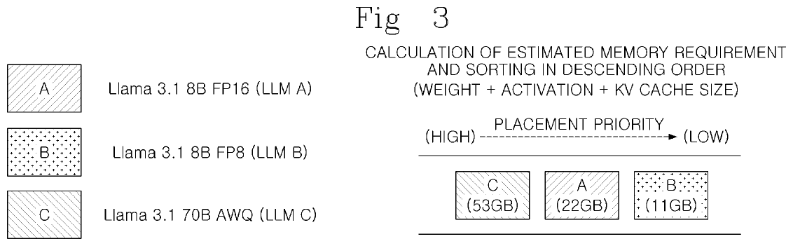

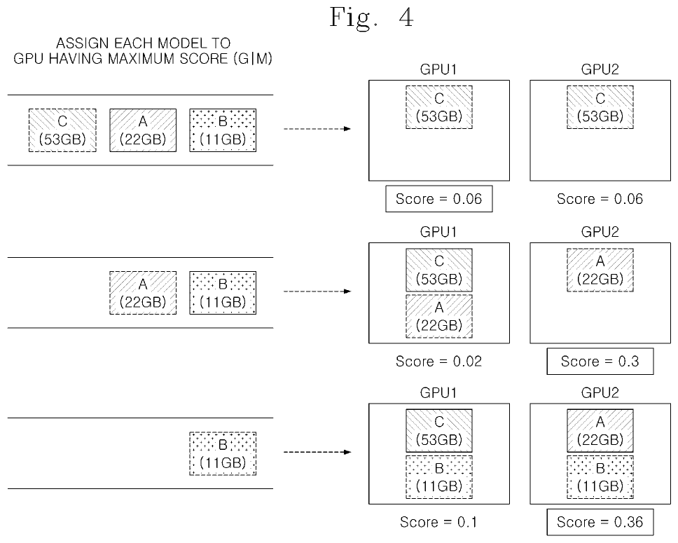

FIG. 3 illustrates the process of determining the placement order of each model depending on priority before selecting the optimal GPU to place each model in the model list according to an embodiment of the present disclosure, and FIG. 4 illustrates the process of placing each model in the model list on each GPU according to a score according to an embodiment of the present disclosure.

In the embodiments in FIGS. 3 and 4, the process of placing three different models on two GPUs is illustrated. By assigning the same specific request rate, input length, and output length to models A, B, and C, the embodiment of FIG. 3 shows a situation where the required memory of each model is 22 GB, 11 GB, and 53 GB, respectively, as indicated in parentheses. Based on the required memory size criteria, models C, A, and B are placed on GPUs in that order. Furthermore, a score is calculated for each GPU, and the model is placed on the GPU with the higher score (if the scores are the same, it is placed on the GPU with the smallest rank index) (the scores shown in FIG. 4 are examples of arbitrary values).

Next, in the local scheduling operation, a batch is formed to perform a chunked prefill to maximize the TTFT SLO satisfaction rate and throughput of the prompts waiting in the serving system. The local scheduling operation tracks the state of each LLM and, when ready to process a new batch, forms a batch to perform a chunked prefill for the corresponding LLM.

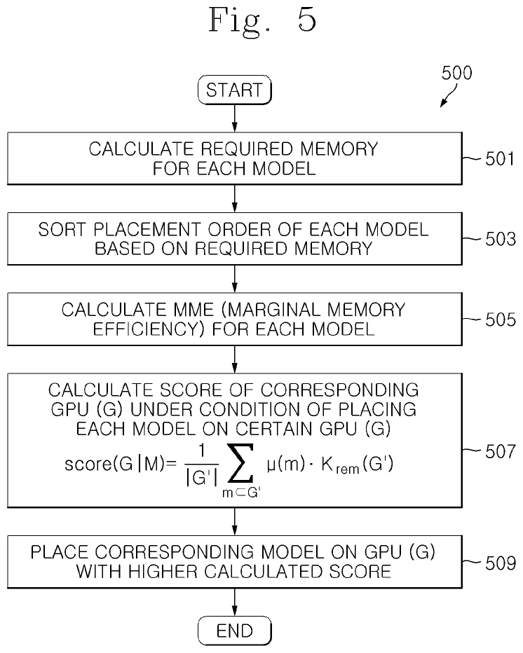

FIG. 5 illustrates a global scheduling method according to an embodiment of the present disclosure.

A global scheduling method 500 according to an embodiment of the present disclosure may include operation 501 of calculating the required memory for each model, operation 503 of sorting the placement order of each model based on the calculated required memory, operation 505 of calculating the MME (Marginal Memory Efficiency) for each model, operation 507 of calculating a score of the corresponding GPU (G) under the condition of placing each model on a GPU (G), and operation 509 of placing the corresponding model on a GPU (G) with a higher calculated score. Here, the score of the corresponding GPU (G) under the condition of placing each model on a GPU (G) may be expressed as follows.

$$score ( G \vert M ) = {\sum }_{i = 0}^{N} \frac{1}{\vert {G}_{i}^{′} \vert} {\sum }_{m ∈ {G}_{i}^{′}} μ ( m ) \cdot {K}_{re m} ( {G}_{i}^{′} )$$

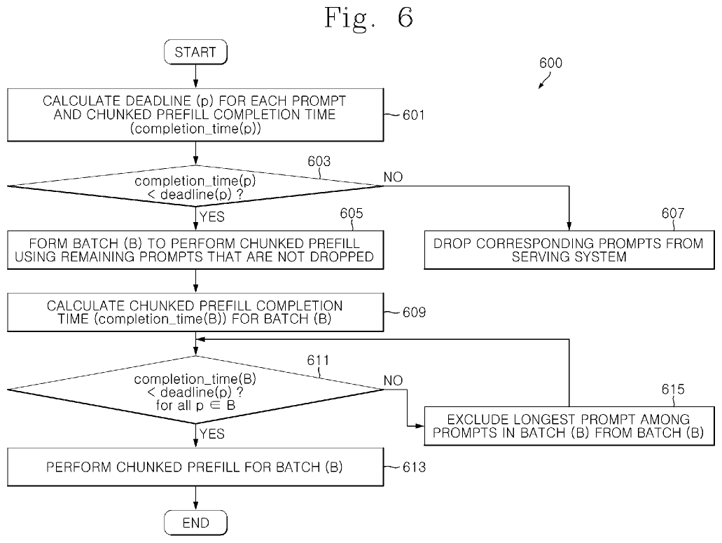

FIG. 6 illustrates a local scheduling method according to an embodiment of the present disclosure.

A local scheduling method 600 according to an embodiment of the present disclosure may be broadly divided into (1) an operation of selecting a prompt to drop and (2) an operation of forming a batch.

### (1) Operation of Selecting a Prompt to Drop

The deadline for each prompt waiting in the serving system is calculated (601). The deadline is calculated as the sum of the arrival time and SLO of each prompt (p).

deadline(p)=arrival_time(p)+SLO(p)

After calculating the estimated time (TTFT) to perform the chunked prefill for each prompt, the completion time of the chunked prefill is calculated in consideration of the current time (601).

completion_time(p)=current_time+TTFT(p)

Prompts whose completion time does not meet the deadline are dropped from the serving system (603 and 607).

Drop p if completion_time(p)≥deadline(p)

### (2) Operation of Forming a Batch

After performing the operation of selecting the prompts to drop, all remaining prompts in the serving system are formed into a batch (B) to perform chunked prefill in this local scheduling operation (605), and then the time at which the chunked prefill for the entire batch is completed is calculated (609).

completion_time(B)=current_time+TTFT(B)

If the completion time does not satisfy the deadline of all prompts in the batch (611), the longest prompt among the prompts in the batch is excluded from the batch (615), and the above process is repeated until the completion time satisfies the deadline of all prompts in the batch.

Drop longest prompt if completion_time(B)≥deadline(p) for a p∈B

If the completion time satisfies the deadline of all prompts within the batch, a chunked prefill is performed for the corresponding batch (613), and the next local scheduling operation is performed.

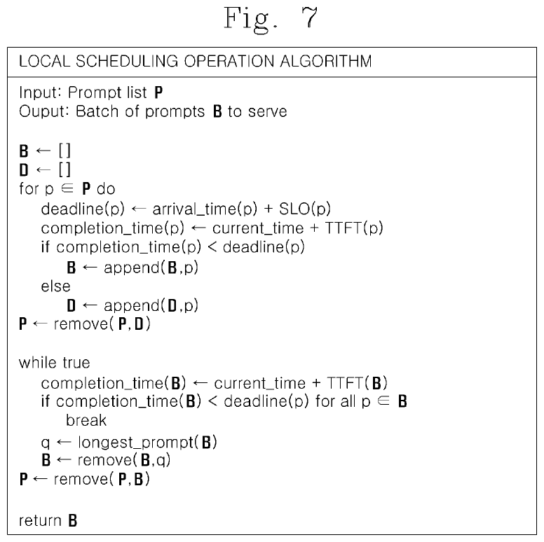

FIG. 7 illustrates the pseudo-code of the processing flow of a local scheduling operation according to an embodiment of the present disclosure.

B and D store a list of prompts included in the batch to be executed in this local scheduling operation and a list of prompts to be dropped, respectively.

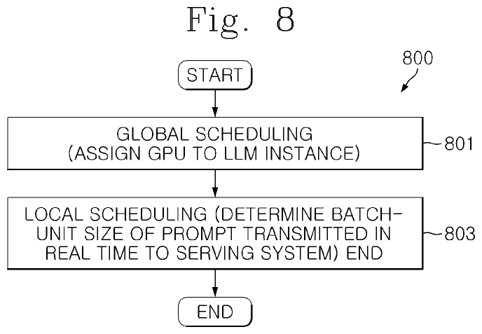

FIG. 8 illustrates a method for scheduling inference operation units according to an embodiment of the present disclosure.

A method 800 for scheduling inference operation units according to an embodiment of the present disclosure may include a global scheduling operation 801 for assigning an appropriate GPU to each LLM instance and a local scheduling operation 803 for determining the batch unit size of a prompt transmitted in real time to a serving system.

The present disclosure may improve the computational and memory resource efficiency of the GPU through such two-stage scheduling of model-unit inference operation unit scheduling (global scheduling) and batch-unit inference operation unit scheduling (local scheduling).

Device to which Proposed Method of Present Disclosure is Applicable

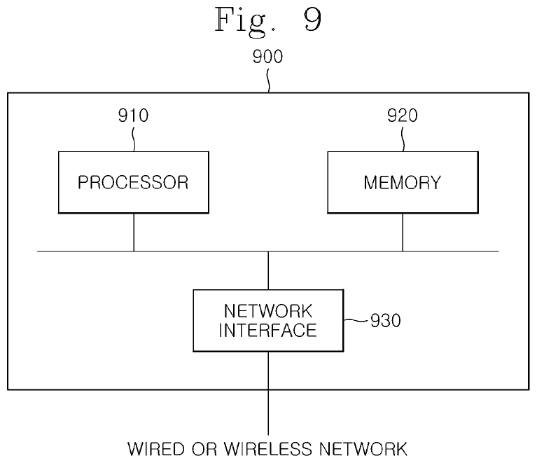

FIG. 9 illustrates an apparatus 900 to which the proposed method of the present disclosure may be applied. The apparatus 900 may refer to a server or terminal that schedules inference operation units of a model (or LLM).

Referring to FIG. 9, the apparatus 900 may be a server device or a terminal device configured to implement a process for a method of scheduling inference operation units.

For example, an apparatus 900 to which the proposed method of the present disclosure may be applied may include network devices such as repeaters, hubs, bridges, switches, routers, gateways, and the like, computer devices such as desktop computers, workstations, etc., mobile terminals such as smartphones, etc., portable devices such as laptop computers, etc., home appliances such as digital TVs, etc., and means of transportation such as automobiles, etc. As another example, the apparatus 900 to which the present disclosure may be applied may be included as part of an ASIC (Application Specific Integrated Circuit) implemented in the form of an SoC (System-on-Chip).

A memory 920 may be connected to a processor 910 during operation, and may store programs and/or instructions for processing and controlling the processor 910, and may store data and information used in the present disclosure, control information required for processing data and information according to the present disclosure, and temporary data generated during the data and information processing process. The memory 920 may be implemented as a storage device such as a ROM (Read-Only Memory), a RAM (Random Access Memory), an EPROM (Erasable Programmable Read-Only Memory), an EEPROM (Electrically Erasable Programmable Read-Only Memory), a flash memory, a SRAM (Static RAM), an HDD (Hard Disk Drive), an SSD (Solid State Drive), and the like.

The processor 910 may be operatively connected to the memory 920 and/or a network interface 930, and may control the operation of respective modules in the apparatus 900. In particular, the processor 910 may perform various control functions for performing method of the disclosure. The processor 910 may also be called a controller, a micro-controller, a micro-processor, a micro-computer, or the like. The proposed method of the present disclosure may be implemented by hardware, firmware, software, or a combination thereof. When implementing the present disclosure using hardware, an ASIC (application specific integrated circuit) or a DSP (digital signal processor), a DSPD (digital signal processing device), a PLD (programmable logic device), an FPGA (field programmable gate array), or the like, configured to perform the present disclosure, may be provided in the processor 910. Meanwhile, when implementing the proposed method of the present disclosure using firmware or software, the firmware or software may include instructions related to modules, procedures, or functions that perform functions or operations necessary for implementing the proposed method of the present disclosure, and the instructions may be stored in the memory 920 or stored in a computer-readable recording medium (not shown) separate from the memory 920, and may be configured to cause, when executed by the processor 910, the apparatus 900 to perform the proposed method of the present disclosure.

In addition, the apparatus 900 may include a network interface device 930. The network interface device 930 may be connected to the processor 910 during operation, and the processor 910 may control the network interface device 930 to transmit or receive wireless/wired signals carrying information, data, signals, and/or messages through a wireless/wired network. The network interface device 930 may support various communication standards such as IEEE 802 series, 3GPP LTE(-A), 3GPP 5G, etc., and may transmit and receive control information and/or data signals according to the corresponding communication standards. The network interface device 930 may be implemented outside the apparatus 900 as needed.

The embodiments described in this specification and the attached drawings are merely exemplary and do not limit the scope of the disclosure in any way. In addition, the connection lines or connection members between the components illustrated in the drawings are examples of functional connections and/or physical or circuit connections, and may be represented as various functional connections, physical connections, or circuit connections that are replaceable or addible in an actual device. In addition, unless specifically stated with “essential,” “important,” etc., the components may not be essential for the application of the present disclosure.

In the specification (especially, in the claims) of the present disclosure, the term “said” and indicative terms similar thereto may be used for both a single element or multiple element. In addition, if a range is stated in the disclosure, it encompasses embodiments to which respective values within the range are applied (unless otherwise stated), and the respective values constituting the range are regarded as being described in the detailed description of the present disclosure. In addition, the operations presented in the method of the disclosure are not intended to be restricted in their sequence, and the sequence thereof may be appropriately changed as needed, unless a certain operation must precede according to the nature of the process. All examples or the use of exemplary terms (e.g., etc.) in the disclosure is merely intended to described the disclosure in detail, and the scope of the disclosure is not limited to the examples or exemplary terms, unless limited by the claims. In addition, those skilled in the art will understand that various modifications, combinations, and changes may be configured according to design conditions and elements without departing from the scope of the appended claims or their equivalents.

What is claimed is:

1. A method for scheduling inference operation units, the method comprising:
a first scheduling operation of assigning one or more models to one or more GPUs; and
a second scheduling operation of determining a batch-unit size of a prompt transmitted in real time to an inference operation system.

2. The method of claim 1,
wherein the first scheduling operation comprises:
calculating required memory for each of the models;
sorting placement order of each of the models based on the required memory;
calculating MME (Marginal Memory Efficiency) for each of the models;
calculating, in a case where each of the models is placed on any one GPU (GPU(G)) among the one or more GPUs in the placement order, a score of the one GPU (GPU(G)); and
sequentially placing each of the models according to the placement order on a GPU with the highest score among the one or more GPUs.

3. The method of claim 2,
wherein the required memory corresponds to a memory requirement comprising a weight size, activation size, and KV cache size of each of the models.

4. The method of claim 2,
wherein the MME is the number of tokens capable of being further processed by each of the models with a unit memory having a predetermined size provided.

5. The method of claim 2,
wherein, in a case where each of the models (M) is placed on any one GPU (GPU(G)) among the one or more GPUs, a score of the one GPU (GPU(G)) is defined by
$$score ( G \vert M ) = {\sum }_{i = 0}^{N} \frac{1}{\vert {G}_{i}^{′} \vert} {\sum }_{m ∈ {G}_{i}^{′}} μ ( m ) \cdot {K}_{re m} ( {G}_{i}^{′} ) ,$$
wherein
G′={m|m is model determined to be placed on GPU G}∪{M}
Kᵣₑₘ(G′):=(total memory of GPU G)−Σ_{m∈G′}(required memory of model m),
μ(m) is the MME of model m, and |G′| is the number of models determined to be placed on GPU G′.

6. The method of claim 1,
wherein the second scheduling operation comprises:
calculating deadline of each prompt among at least one prompt waiting within the inference operation system;
calculating an estimated time (TTFT) to perform chunked prefill for each prompt, and then calculating a completion time of the chunked prefill in consideration of the current time;
dropping the prompt whose completion time of the chunked prefill exceeds the deadline from the inference operation system;
forming a batch to perform chunked prefill on all prompts remaining within the inference operation system that are not dropped;
calculating a completion time of the chunked prefill for the batch;
based on the completion time of the chunked prefill for the batch not satisfying the deadline of all prompts within the batch, excluding the longest prompt among the prompts within the batch from the batch; and
repeatedly executing the excluding of the longest prompt among the prompts within the batch from the batch until the completion time of the chunked prefill for the batch satisfies the deadline of all prompts within the batch.

7. The method of claim 6,
wherein the deadline is calculated as a sum of an arrival time and an SLO of each prompt.

8. The method of claim 6, further comprising
performing chunked prefill for the batch in a case where the completion time of the chunked prefill for the batch satisfies the deadline of all prompts within the batch.

9. A computer program stored on a medium for executing, in conjunction with hardware, the method of scheduling inference operation units of claim 1.

10. An apparatus for scheduling inference operation units, the apparatus comprising a processor,
wherein the processor is configured to perform:
first scheduling of assigning one or more models to one or more GPUs; and
second scheduling of determining a batch-unit size of a prompt transmitted in real time to an inference operation system.

11. The apparatus of claim 10,
wherein the first scheduling comprises:
calculating required memory for each of the models;
sorting placement order of each of the models based on the required memory;
calculating MME (Marginal Memory Efficiency) for each of the models;
calculating, in a case where each of the models is placed on any one GPU (GPU(G)) among the one or more GPUs in the placement order, a score of the one GPU (GPU(G)); and
sequentially placing each of the models according to the placement order on a GPU with the highest score among the one or more GPUs.

12. The apparatus of claim 11,
wherein the required memory corresponds to a memory requirement comprising a weight size, activation size, and KV cache size of each of the models.

13. The apparatus of claim 11,
wherein the MME is the number of tokens capable of being further processed by each of the models with a unit memory having a predetermined size provided.

14. The apparatus of claim 11,
wherein, in a case where each of the models (M) is placed on any one GPU (GPU(G)) among the one or more GPUs, a score of the one GPU (GPU(G)) is defined by
$$score ( G \vert M ) = {\sum }_{i = 0}^{N} \frac{1}{\vert {G}_{i}^{′} \vert} {\sum }_{m ∈ {G}_{i}^{′}} μ ( m ) \cdot {K}_{re m} ( {G}_{i}^{′} ) ,$$
wherein
G′={m|m is model determined to be placed on GPU G}∪{M}
Kᵣₑₘ(G′):=(total memory of GPU G)−Σ_{m∈G′}(required memory of model m),
μ(m) is the MME of model m, and |G′| is the number of models determined to be placed on GPU G′.

15. The apparatus of claim 11,
wherein the second scheduling comprises:
calculating deadline of each prompt among at least one prompt waiting within the inference operation system;
calculating an estimated time (TTFT) to perform chunked prefill for each prompt, and then calculating a completion time of the chunked prefill in consideration of the current time;
dropping the prompt whose completion time of the chunked prefill exceeds the deadline from the inference operation system;
forming a batch to perform chunked prefill on all prompts remaining within the inference operation system that are not dropped;
calculating a completion time of the chunked prefill for the batch;
based on the completion time of the chunked prefill for the batch not satisfying the deadline of all prompts within the batch, excluding the longest prompt among the prompts within the batch from the batch; and
repeatedly executing the excluding of the longest prompt among the prompts within the batch from the batch until the completion time of the chunked prefill for the batch satisfies the deadline of all prompts within the batch.

16. The apparatus of claim 15,
wherein the deadline is calculated as a sum of an arrival time and an SLO of each prompt.

17. The apparatus of claim 15,
wherein the processor is configured to further perform chunked prefill for the batch in a case where the completion time of the chunked prefill for the batch satisfies the deadline of all prompts within the batch.
